(19) United States
(12) Patent Application Publication
(10) Pub. No.: US 2012/0099820 A1
(43) Pub. Date: Apr. 26, 2012

(54) TWO DIMENSIONAL OPTICAL CONNECTOR

(76) Inventors: David R. Rolston, Beaconsfiled (CA); Rajiv Iyer, Brossard (CA); Shao-Wei Fu, Delson (CA); Nicolas Belanger, Montreal (CA)

(21) Appl. No.: 13/257,553

(22) PCT Filed: Mar. 22, 2010
(86) PCT No.: PCT/CA2010/000438

§ 371 Date: Oct. 18, 2011

Related U.S. Application Data
(60) Provisional application No. 61/161,829, filed on Mar. 20, 2009.

(51) Int. Cl. G02B 6/40; G02B 6/26

(52) U.S. Cl. 385/59; 264/1.25

(57) ABSTRACT

There is described a method for fabricating an optical connector comprising: embedding each one of a plurality of first optical waveguides in a corresponding one of a plurality of first grooves of a first substrate; embedding each one of a plurality of second optical waveguides in a corresponding one of a plurality of second grooves of a second substrate; abutting the plurality of first optical waveguides and the plurality of second optical waveguides against walls of the plurality of first grooves and the plurality of second grooves, respectively, by securing a spacer plate between the first substrate and the second substrate so that the first optical waveguides and the second optical waveguides extend along a same axis, thereby obtaining an optical assembly having a front end substantially perpendicular to the axis; and beveling the front end of the optical assembly, thereby obtaining a beveled end for the first optical waveguides and a beveled end for the second optical waveguides offset along the axis for separately providing optical access by side coupling to the plurality of first optical waveguides and the plurality of second optical waveguides.

### CROSS-REFERENCE TO RELATED APPLICATIONS

The present application claims priority under 35 USC §119(e) of US Provisional Patent Application bearing Ser. No. 61/161,829, filed on Mar. 20, 2009, the contents of which are hereby incorporated by reference.

### FIELD OF THE ART

The invention relates to the field of optical connectors. More precisely, it relates to the field of micro-optical lens relay systems for 2-D arrays of optoelectronic devices and optical waveguides.

### BACKGROUND OF THE ART

Increasing the optical channel density for very-short reach optical data communications has been studied by numerous companies and universities over the past decade. There are various arrayed optical transceiver products, but these typically are offered as single linear arrays of lasers and photodetectors. The SNAP-12, POP4 and QSFP type transceivers are all examples of products that are based on 1×12 or 1×4 arrays of lasers. These offer a channel density advantage over the single channel transceiver types such as the small form-factor (SFP) and 10 Gigabit small form-factor (XFP) products.

There have been numerous techniques employed to align the positions of optical waveguides such as optical fibers in front of light emitters or detectors. Some technologies use methods of aligning optical waveguides to the active area of the light emitters either by directly coupling the end-facet to the light emitter or through a lens—such as the TOSA/ROSA TO4 package used in most SFP and XFP transceiver modules. Other lensing techniques allow multiple optical waveguides to be aligned with multiple light sources in a linear array, while other designs attempt to have even more optical channels by using 2-D arrays of lenses with prisms or beam-splitters.

Concepts that involve 2-D arrays of lasers and photodetectors flip-chipped to silicon complementary metal-oxide-semiconductor (CMOS) have been designed to take advantage of the planar surface of the CMOS chip to offer a tremendously large area for optical coupling. However, the optical coupling mechanism of getting the light into or out of the optical fiber has typically involved either a direct coupling or through a lens system. A large majority of designs involve a reflector or mirror at or near the end of the optical fiber or waveguide to allow a more easily manufactured and more compact assembly.

There is a need for an improved design for micro-optical lens relay systems for 2-D arrays of optoelectronic devices and optical waveguides.

### SUMMARY

There is described an assembly that allows for a two-dimensional array of light emitters and/or detectors to be optically coupled with a two-dimensional array of optical waveguides such as optical fibers using a beveled optical fiber concept.

There is also described a method of manufacturing these devices, as well as the means to assemble an optical relay system between the optical waveguides and the light emitters and/or detectors.

In accordance with a first broad aspect, there is provided method for fabricating an optical connector comprising: embedding each one of a plurality of first optical waveguides in a corresponding one of a plurality of first grooves of a first substrate; embedding each one of a plurality of second optical waveguides in a corresponding one of a plurality of second grooves of a second substrate; abutting the plurality of first optical waveguides and the plurality of second optical waveguides against walls of the plurality of first grooves and the plurality of second grooves, respectively, by securing a spacer plate between the first substrate and the second substrate so that the first optical waveguides and the second optical waveguides extend along a same axis, thereby obtaining an optical assembly having a front end substantially perpendicular to the axis; and beveling the front end of the optical assembly, thereby obtaining a beveled end for the first optical waveguides and a beveled end for the second optical waveguides offset along the axis for separately providing optical access by side coupling to the plurality of first optical waveguides and the plurality of second optical waveguides.

In accordance with a second broad aspect, there is provided a optical connector comprising: a first substrate comprising a plurality of first grooves extending along an axis on a first waveguide receiving surface; a second substrate comprising a plurality of second grooves extending along the axis on a second waveguide receiving surface; a plurality of first optical waveguides, each received in a corresponding one of the plurality of first grooves; a plurality of second optical waveguides, each received in a corresponding one of the plurality of second grooves; and a spacer plate secured between the first substrate and the second substrate to abut the plurality of first optical waveguide and the plurality of second optical waveguides against walls of the plurality of first grooves and the plurality of second grooves, respectively, the first substrate, the first optical waveguides, the spacer plate, and the second optical waveguides being beveled at a given end to form a beveled connector end, the given end for the first waveguides and the given end for the second waveguides being offset along the axis for separately providing optical access by side coupling to the plurality of first optical waveguides and the plurality of second optical waveguides.

For the present specification, the term “waveguide” should be understood to mean a device that constrains or guides the propagation of electromagnetic radiation along a path defined by the physical construction of the guide, including light guides such as optical fibers. While the grooves of the substrates are generally described as v-shaped, it should be noted that this is exemplary only and that the grooves can be v-shaped, u-shaped, or have any other shape allowing waveguides to be inserted and aligned properly, held either by the use of epoxy or some other type of adhesive, or by a precision fabrication of the grooves themselves that perfectly match the shape and size of the waveguides, and therefore does not require any type of adhesive. The substrates or chips holding the waveguides may be made of glass, silicon, or any other equivalent material allowing optical access to the waveguide while providing adequate support. The beveled front ends of the waveguides may be provided at a 45° angle, or any other angle that, in combination with the material of the waveguide, will allow total internal reflection to occur to properly direct light entering or exiting the waveguide.

### BRIEF DESCRIPTION OF THE DRAWINGS

Further features and advantages of the present invention will become apparent from the following detailed description, taken in combination with the appended drawings, in which:

FIG. 01 is a perspective view of the 2-D optical ferrule showing the 45-degree beveled front end and the locations of the two sets of 1×12 optical fiber arrays within the silicon v-groove chips, in accordance with an embodiment;

FIG. 02 is a cross-sectional side view of the 2-D optical ferrule where the optical waveguides are horizontal and lying within their respective v-grooves within the two silicon chips, in accordance with an embodiment;

FIG. 03 is a cross-sectional front view of the 2-D optical fiber array where the optical fiber arrays line up on top of each other, in accordance with an embodiment;

FIG. 04 is a cross-sectional front view of a slightly different arrangement where the optical fiber arrays are shifted half-a-pitch from each other, in accordance with an embodiment;

FIG. 05 is a cross-sectional top view of the 2-D optical fiber array where the optical fiber arrays line up on top of each other, in accordance with an embodiment;

FIG. 06 is a cross-sectional top view of a different arrangement where the optical fiber arrays are shifted half-a-pitch from each other, in accordance with an embodiment;

FIG. 07 is an exploded perspective view showing the basic parts in the 2-D optical ferrule assembly (not including epoxy), in accordance with an embodiment;

FIG. 08 is an exploded perspective view showing the basic parts in the 2-D optical ferrule assembly that include 2 precision glass spacers (not including epoxy), in accordance with an embodiment;

FIG. 09 is a front perspective view of an exemplary embodiment of the 2-D optical ferrule that includes a standard type 2×12 MT plastic ferrule on the back end;

FIG. 10 is a back perspective view of an exemplary embodiment of the 2-D optical ferrule that includes a standard type 2×12 MT plastic ferrule showing the 2×12 array of flat-polished optical waveguides and the 2 alignment dowel pin holes;

FIG. 11 is a top perspective view from the back showing the pair of alignment v-groove trenches on the top and bottom v-groove chips with two associated alignment pins along with two optical waveguides from the back side, in accordance with an embodiment;

FIG. 12 is a cross-sectional front view of a different embodiment of the 2-D optical ferrule showing a pair of alignment v-groove trenches on the top and bottom v-groove chips with two associated alignment pins, in accordance with an embodiment;

FIG. 13 is a perspective view of another exemplary embodiment of the 2-D optical ferrule where the 2 sets of 1×12 optical waveguides are held by a silicon v-groove chip on the top and a glass v-groove on the bottom;

FIG. 14 is a cross-sectional side view of another exemplary embodiment of a 2-D optical ferrule where the optical waveguides are horizontal and the top set of optical waveguides lay in the top silicon v-groove chip and the bottom set of optical waveguides lie in the bottom glass v-groove chip;

FIG. 15 is a perspective view of a glass plate with a 2×12 micro-lens array patterned on a single side of the plate, in accordance with an embodiment;

FIG. 16 is a perspective view of a glass plate with two sets of 2×12 micro-lens arrays patterned on each side of the plate, in accordance with an embodiment;

FIG. 17 is a perspective view of an optoelectronics carrier with a 2×12 patterned array of optoelectronic devices on a chip that has been wire-bonded to the substrate and includes a vertical spacer that surrounds the optoelectronic chip on three side, in accordance with an embodiment;

FIG. 18 is a perspective view of the 2 micro-lens plates placed and aligned over the optoelectronic chip using the vertical spacer, in accordance with an embodiment;

FIG. 19 is a side view of an exemplary 3 lens relay system with a vertical-cavity surface-emitting laser (VCSEL) as the light source and the beveled optical fiber tip as the final image plane, in accordance with an embodiment;

FIG. 20 is a cross-sectional side view of an exemplary 2-D optical ferrule aligned over the micro-lens arrays and showing the path of light in the lens system between the optoelectronic devices and the tips of the beveled optical fiber arrays, in accordance with an embodiment;

FIG. 21 is a front cross-sectional view of an exemplary 2-D optical ferrule aligned over the micro-lens arrays and showing the path of light in the lens system between the optoelectronic devices and the tips of the beveled optical fiber arrays, in accordance with an embodiment;

FIG. 22 is a perspective view of an exemplary 2-D optical ferrule that contains a 4×12 array of beveled optical fiber tips that are held within spacers and glass v-grooves, in accordance with an embodiment; and

FIG. 23 is a cross-sectional side view of an exemplary 2-D optical ferrule that contains a 4×12 array of beveled optical fiber tips, in accordance with an embodiment.

It will be noted that throughout the appended drawings, like features are identified by like reference numerals.

### DETAILED DESCRIPTION

Embodiments of the optical connector, optical assembly, and method of manufacture described herein will first be presented with regard to a 2×12 array of optical waveguides that is coupled with a 2×12 array of light emitters and/or detectors, such as vertical cavity surface emitting lasers (VCSEL), but can be scaled to include larger arrays (4×12, 4×4, 6×12, etc. . . . ) and combinations of different optoelectronic chips as well as different combinations of emitters and detectors on the same chip.

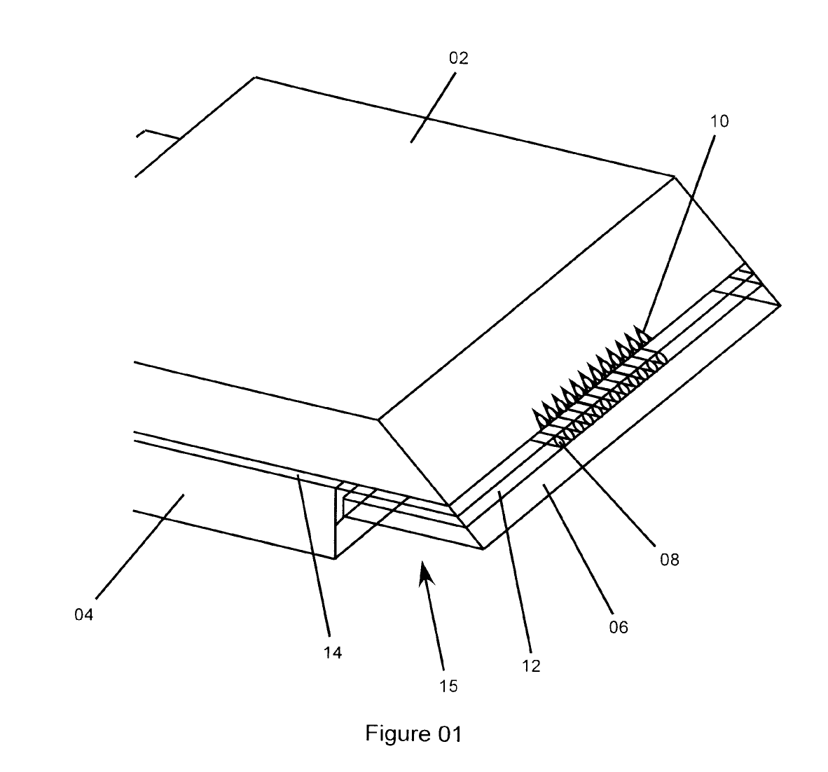

FIG. 1 illustrates one embodiment of a 2-D connector assembly in which an upper silicon v-groove chip or substrate [02] holds an upper set of 1×12 optical waveguides [10] within respective grooves which extend along a longitudinal axis of the substrate [02]. A spacer [14] 0.125-mm thick is used to separate the upper silicon v-groove chip [02] from a lower silicon v-groove chip or substrate [04]. A lower set of 1×12 optical waveguides [08] are placed in respective lower grooves which extend along the longitudinal axis of the lower silicon v-groove chip [04], but they are allowed to protrude from the lower silicon v-groove chip a distance of approximately 1.5-mm prior to the front angle polish of the assembly. After the angle polishing of the front, the lower optical waveguides protrude less than 1.5-mm but normally more than 1-mm. The portion of the fibers [08] uncovered by the chip [04] forms an access region from which light may be coupled into fibers [08] and [10] by side coupling. It should be understood that the access region has a size adapted to receive an optoelectronic arrayed device comprising emitters for coupling light into the fibers [08], [10] or receiving light from the fibers [08], [10]. While the fibers [08] protrude 1.5-mm from the chip [04] before the angle polishing of the front end of the assembly, it should be understood that the fibers [08] may protrude from the chip [04] by a distance other than 1.5-mm as long as this allows clearance for the optoelectronic arrayed device to be placed under the two sets of optical fiber arrays. Transparent thermal and/or UV curing epoxy is used to join all the parts together.

In one embodiment, the specific region under the two sets of optical waveguides near the front [15] can be coated with more epoxy [12] and an additional cover [06] made from any adequate transparent material such as glass or plastic for example can be used to ensure that a homogenous optical pathway, free of curvatures, bumps and scattering sites, can be obtained. In another embodiment, it has also been found that with very careful application of epoxy, the glass spacer [06] is not necessary, and that the lower row of optical waveguides [08] becomes only half embedded in the transparent epoxy. However, polishing of the front beveled end then requires more careful procedures not to damage the tips of the optical waveguides.

It should be understood that the spacer [14] may be made from any adequate transparent material allowing light to propagate therethrough. For example, the spacer [14] may be made from glass, plastic, or the like. The spacer [14] is used to maintain the fibers [10] in their corresponding grooves of the chip [02] and the fibers [08] in their corresponding grooves of the chip [04].

It should also be understood that the thickness of the spacer [14] is exemplary only. The thickness of the spacer [14] is chosen in conjunction with the angle of the beveled end of the connector assembly to provide an adequate offset [13] between the fibers [08] and [10] along the longitudinal axis of the connector assembly.

According to one embodiment, an assembly contains an arranged set of two 1×12 parallel optical waveguides such that each of the 12 optical waveguides [08] and [10] in a set are precisely pitched in a horizontal row at 0.25-mm. The two sets of optical waveguides are also pitched vertically at 0.25-mm from each other one on top of the other. This forms a regular 2×12 array of optical waveguides with pitch in both x and y of 0.25-mm. It should be noted that the 0.25-mm pitch is used only to be consistent with current trends in device and part manufacturing and can also be any other reasonable pitch.

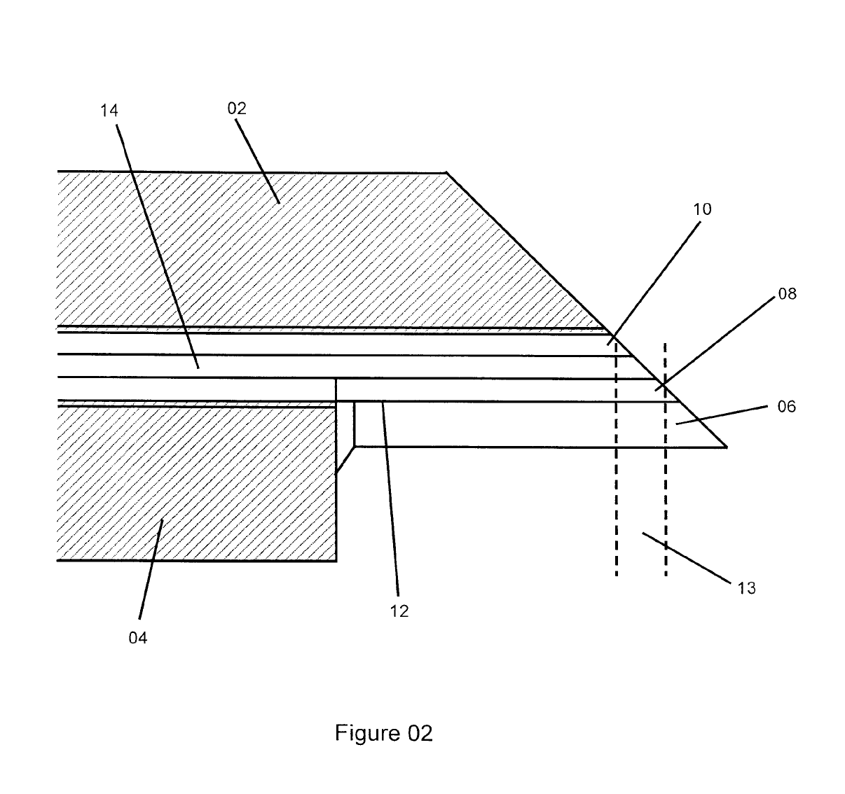

The cut-away side view of the assembly in FIG. 2 shows the upper and lower sets of optical waveguides [08], [10] in their respective v-grooves and the spacing of the optical waveguides in the vertical direction. Note that the thickness of the glass spacer, in this case 0.125-mm, adjusts the horizontal spacing of the tips of the optical waveguides, thereby impacting the horizontal separation [13] of the optoelectronic devices. This allows final implementations that can use either two separate 1×12 optoelectronic device arrays, spaced by some amount, as well as integrated 2×12 optoelectronic arrays on a single chip.

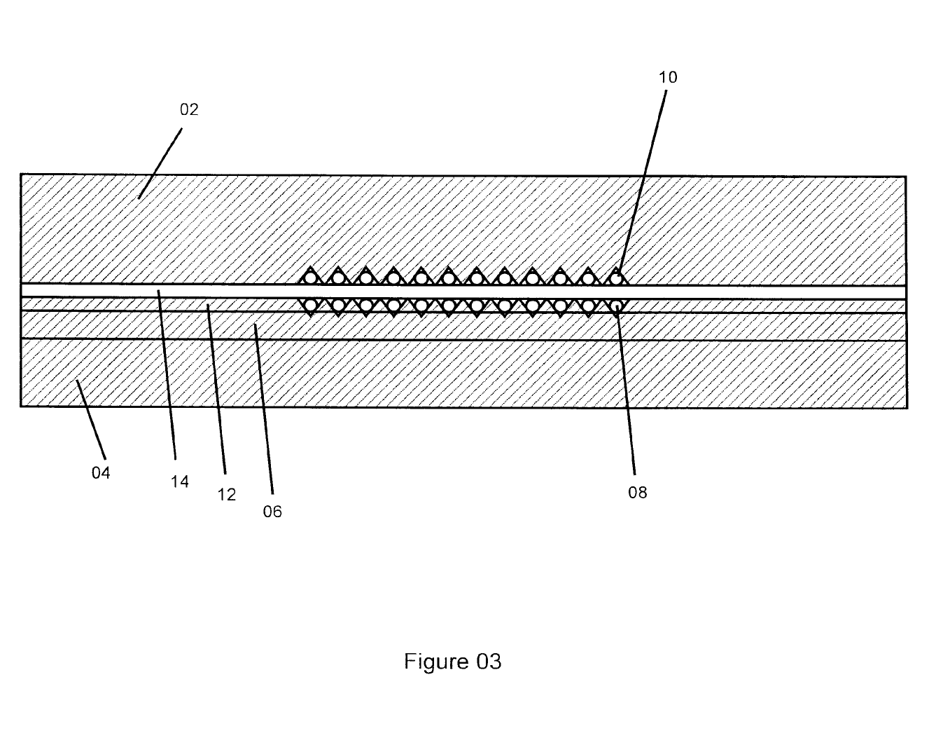

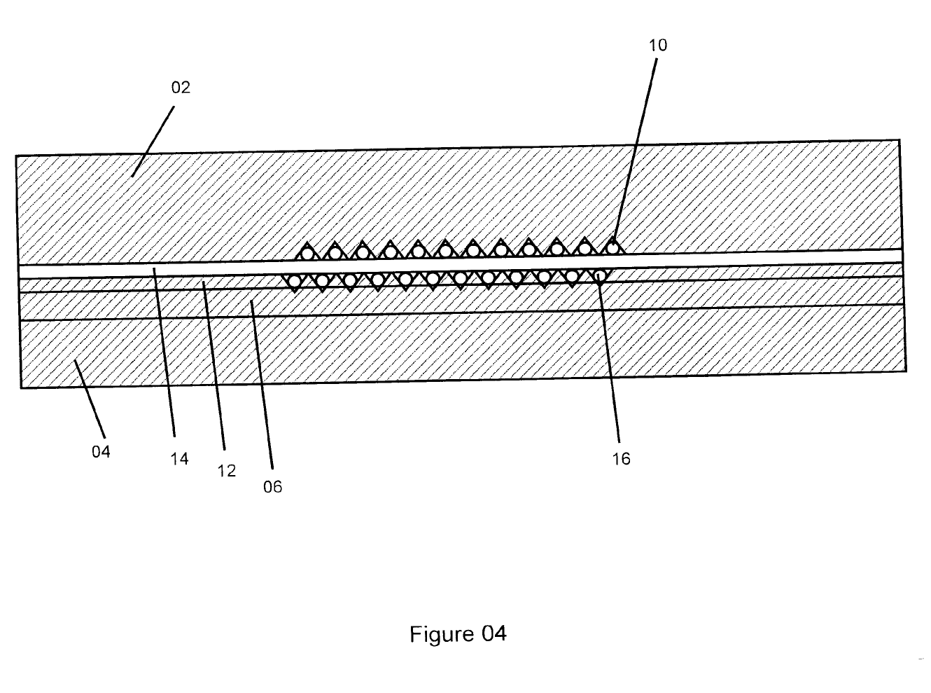

FIGS. 3 and 4 illustrate two embodiments that show the front portion of the optical connector. The optical path between the upper optical fiber array tips and an emitter or a detector is completely through the lateral side of the lower optical fiber array. This may cause some optical refraction and scattering of light depending on the index matching of each material in the path. Therefore, an optional feature of the v-groove positions is to have the upper and lower v-groove structures offset by half the pitch, for example. This allows for a more homogeneous optical path to the tips of the upper optical fiber array.

In FIG. 3, the v-groove structures have been positioned such that the sets of optical waveguides [08], [10] are vertically aligned on top of each other. The accuracy of this positioning is important to the eventual alignment of the 2-D optical connector on top of an optoelectronic device array. However, the optical path of this arrangement for light to the upper set of optical waveguides [10] is through the lateral sides of the lower optical waveguides [08] first. A second embodiment is to displace the lower set of optical waveguides [08] some distance with respect to the upper optical waveguides [10], as shown in FIG. 4. This displacement, in one embodiment at exactly half the pitch, can allow an optical path clear of the lateral sides of all optical waveguides. In this case, the pitch of the optoelectronic devices must be similar.

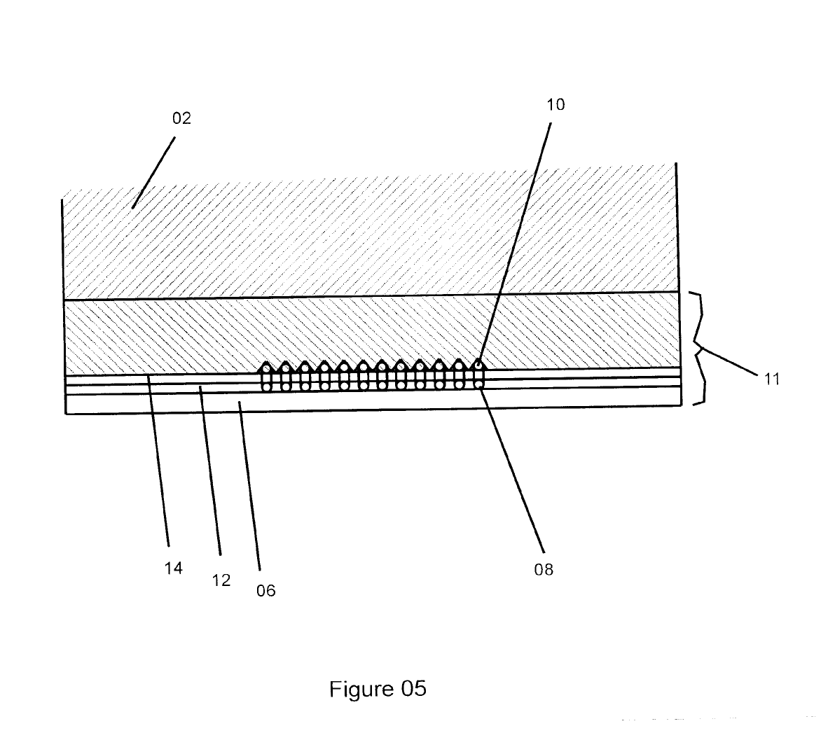

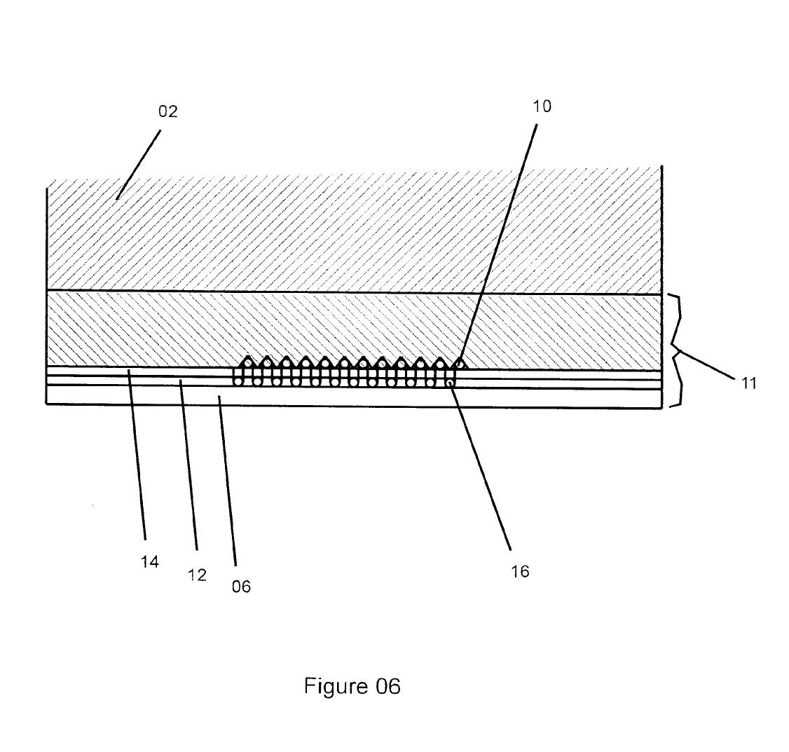

FIGS. 5 and 6 are views from the top of the optical connector looking down through the glass spacer and the optical fiber tips. This is the view that would normally be used during the alignment of the tips of the optical waveguides to the optoelectronic devices. Note that the beveled front end of the assembly [11] may also be coated using any adequate reflecting coating such as a metallic reflective coating for example, and therefore it would not be possible to see through the glass. The displaced position of the optical waveguides is also shown in FIG. 6.

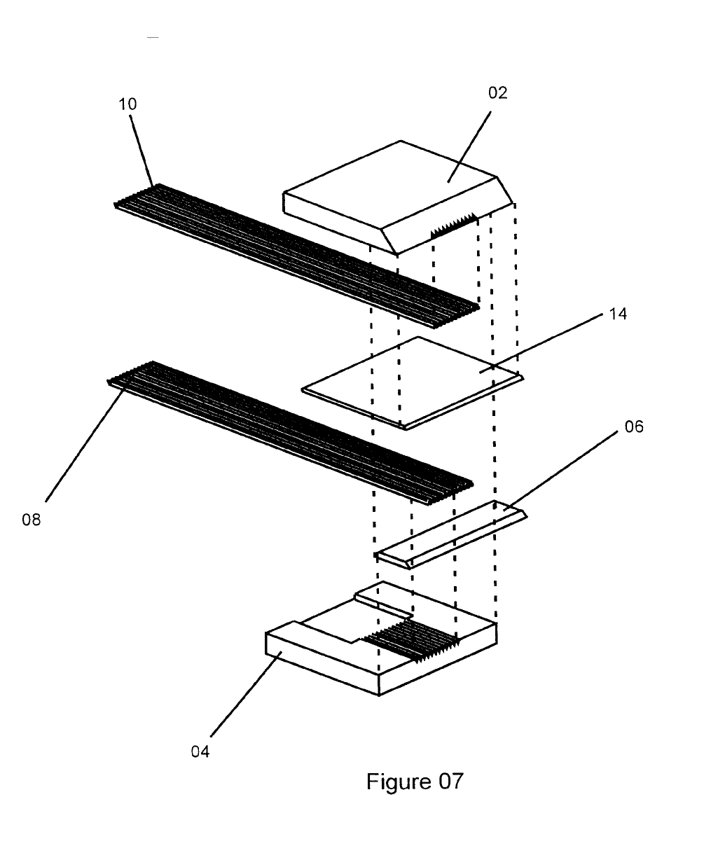

The exploded view of the 2-D optical connector assembly is shown in FIG. 7. There is illustrated the relative positions of the six parts that comprise the assembly, in accordance with one embodiment. The assembly method can vary greatly, but may involve placing the optical waveguides [10] into silicon v-groove chip [02], placing transparent epoxy or any other adequate adhesive, and covering with the glass spacer [14]. The second set of optical waveguides [08] is then placed on the glass spacer's other side and then covered by the lower silicon v-groove chip [04] and positioned in place. Thermally curing epoxy may be used at this step, or combinations of UV and thermal epoxy.

In one embodiment, the glass plate [06] may be removably secured to the portion of the fibers [08] protruding from the substrate [04] and subsequently removed once the front end of the assembly has been beveled. For example, a wax layer may be deposited on the portion of the optical waveguides [08] protruding from the substrate [04] and the cover plate [06] is pressed against the wax layer. The wax layer allows to removably secure the cover plate [06] to the fibers [08] and to maintain the position of the fibers [08] during the beveling of the front end of the assembly. For example, a polyethylene phthalate wax may be used. This wax melts at about 120° C. and is soluble in acetone. Once the polishing step is performed, the cover plate [06] may be removed by heating the wax. The remaining wax may be removed using acetone or any other adequate liquid in which the wax is soluble.

In another embodiment, the cover [06] may be permanently secured to the portion of the waveguides [08] protruding from the substrate [04].

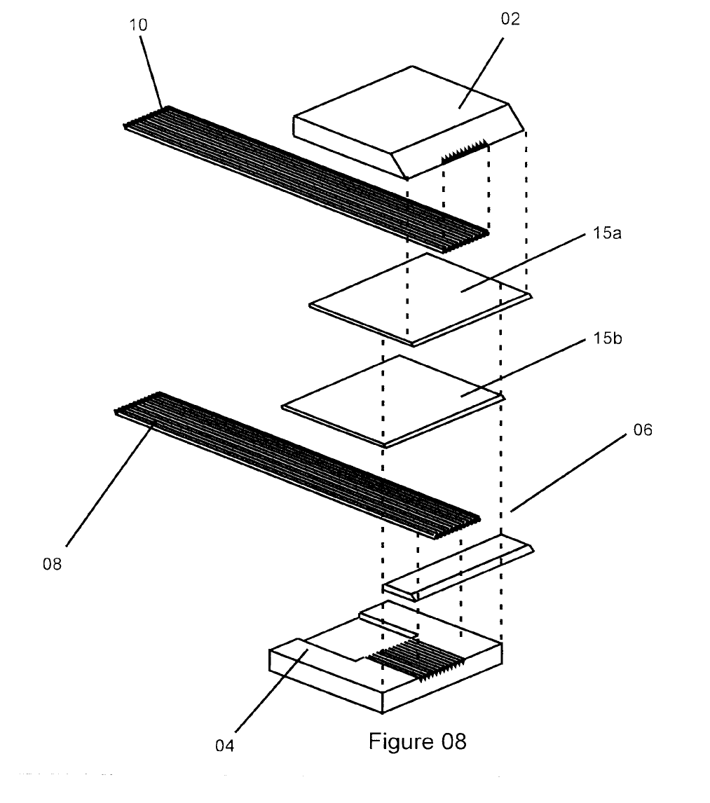

In one embodiment, a precision glass spacer can be composed of two spacers, each half as thick as a single spacer, where one spacer is joined to the upper silicon v-groove chip and the other is joined to the lower silicon v-groove chip to hold the optical waveguides in place. Subsequently, the two halves can then be joined together using optically transparent epoxy. This is illustrated in FIG. 8, where two glass spacer plates [15a] and [15b], each half as thick as the full spacer plate [14] are used. In this way, the two halves of the assembly can be prepared separately and then positioned and joined as a final step.

In one embodiment of the method, the optical waveguides are held in place using precision fabricated silicon v-groove chips [02], [04] where the optical waveguides [08], [10] are seated in the v-groove trenches such that each optical waveguide makes contact with the walls of the v-grooves to position them at the 0.25-mm pitch, for example. The two silicon v-groove chips [02], [04], each containing a 1×12 set of optical waveguides [10], [08], respectively, are then placed face-to-face with a precision glass spacer [14] therebetween, and are fixed in place using transparent optical epoxy. The lower silicon v-groove chip [04] is joined so that it is recessed from the front end of the upper silicon v-groove chip [04] by approximately 1.5-mm, but where the optical waveguides [08] in the lower silicon v-groove chip [04] still protrude to substantially the same length as the upper set of optical waveguides [10]. This provides an optical, or visual, access to the lateral sides of both sets of optical waveguides [08], [10] from below. Further to this, a small glass cover [06] may be added to cover the 1.5-mm of lower extended optical waveguides. Transparent epoxy, either thermally or via UV curing, is used throughout the assembling process to hold the optical waveguides [08], [10] in their respective v-grooves and also to hold the small glass cover [06], if any, in place over the optical waveguides [08]. Given the short distance that the lower optical waveguide set [08] extends beyond the lower silicon v-groove chip [04], the optical waveguides [08] will remain well pitched during the subsequent curing in place of the small glass cover [06].

The assembly is then placed in a lapping/polishing machine at a 45-degree angle so that the front end of the assembly is beveled at 45-degrees, including the tips of all of the optical waveguides. The beveled tips of all the optical waveguides [08], [10] are then optically accessible from below and through the bottom of the small glass plate [06], if any, for light side coupling. If light is directed at the cores of the optical waveguides coincident with the 45-degree beveled end tips, the light will be reflected at 90-degrees using total internal reflection and coupled into the guiding cores of the optical waveguides. This beveled end facet can also be metalized with gold, silver, or other reflective metals to allow for better optical reflection.

It should also be noted that the precision glass spacer thickness and the angle of the beveled front end of the 2D-connector adjust the offset [13] between the beveled ends of the waveguides [08], [10], and the spacing between the optoelectronic arrays on the carrier by simple geometry. The spacer [14] also affects the optical path length and should be accounted for in subsequent alignment steps.

In one embodiment, the 2-D optical connector has a back end that is convenient for external optical connections, such as a fiber optic patch cord. In a further embodiment, an MT-style plastic flat-end polished connector can be used that terminates in a 2×12 set of optical waveguides. These connectors can be adapted and/or modified to abut the back end of the 2-D optical connector to form a single coupling module that allows a 2×12 array of optical waveguides with a 45-degree reflection on the front end to connect with an industry standard flat-end polished connector with alignment dowel pin holes on the back end.

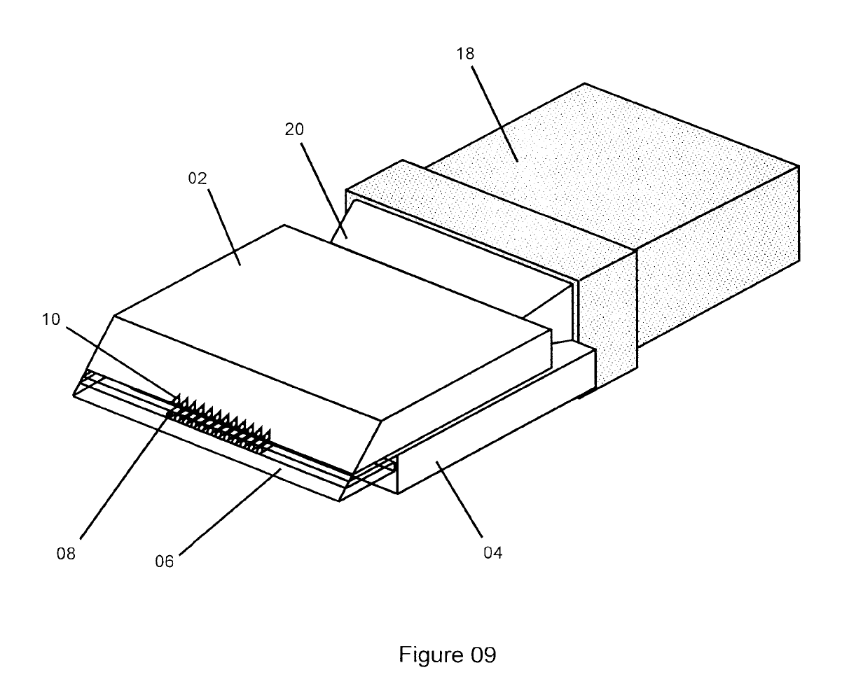

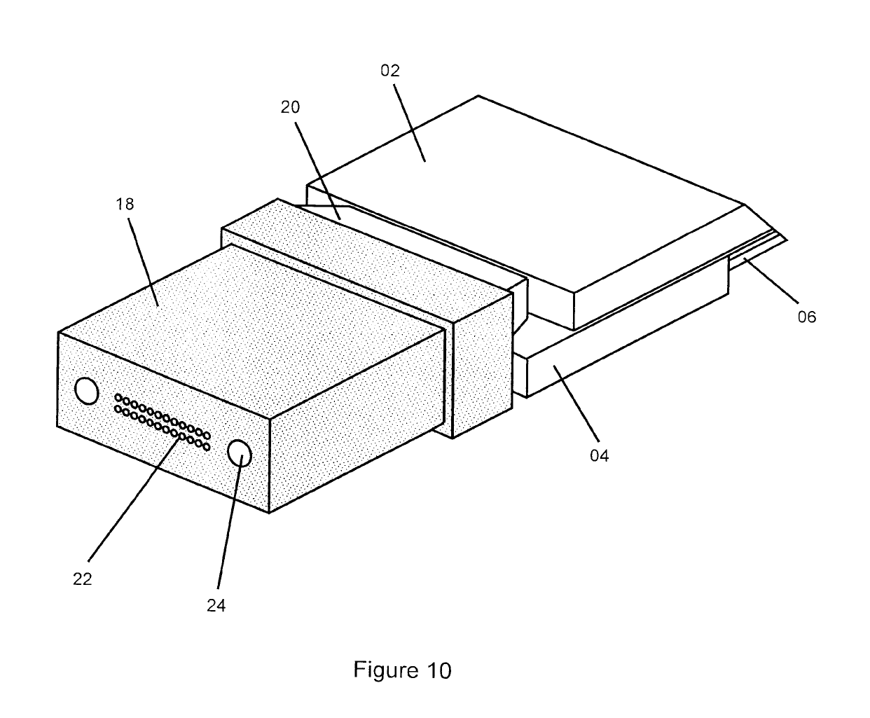

FIGS. 9 and 10 are the front and back perspective views, respectively, of a 2-D optical connector that includes an industry standard optical termination called an MT ferrule [18]. This version of the MT ferrule has a 2×12 array of flat-polished optical fiber tips [22], and a precision placed pair of alignment dowel pin holes [24] to allow MT-to-MT ferrule mating. The joining portion [20] between the silicon v-groove chips and the MT is a reinforcement of either epoxy or formed plastic that joins the MT to the silicon. This type of terminated 2-D optical connector can be accomplished in numerous ways, although the end effect is to produce a connector that has a front beveled face for coupling to an optoelectronic device array and a back face that couples to an industry standard optical connector assembly.

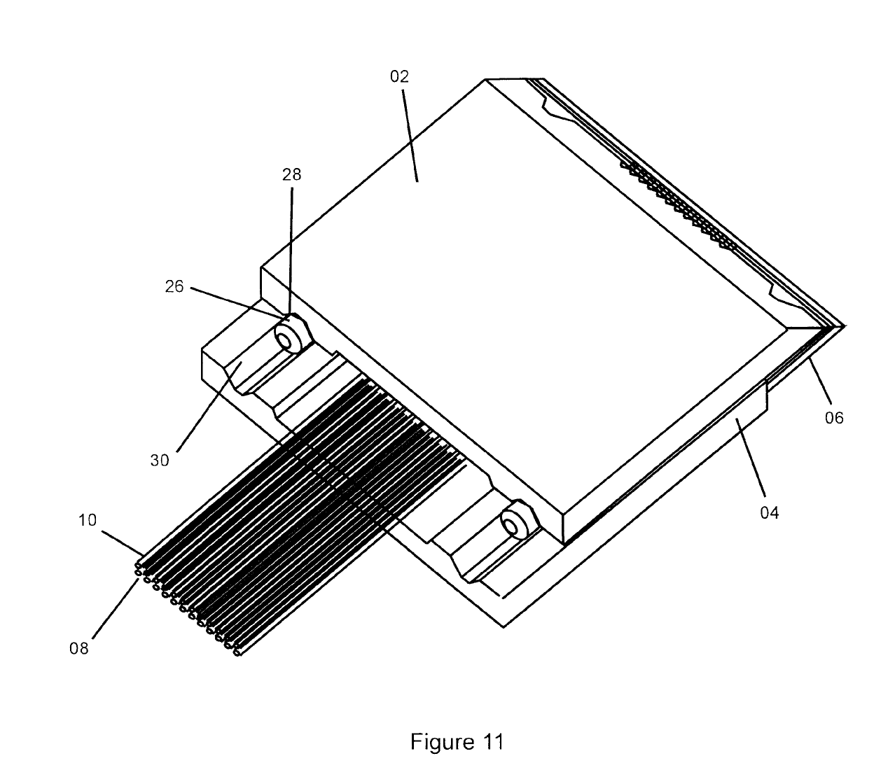

In another embodiment, the back end of the 2-D optical ferrule remains as a fiber pig-tail. This is an arbitrary length of optical fiber ribbon eventually terminated in a variety of optical termination ends. FIG. 11 shows the 2-D optical connector used as a fiber pig-tailed component. The long lengths of optical waveguides are terminated at some distance by a variety of different optical terminations including MT, LC and ST connecters taken in groups or single fibers.

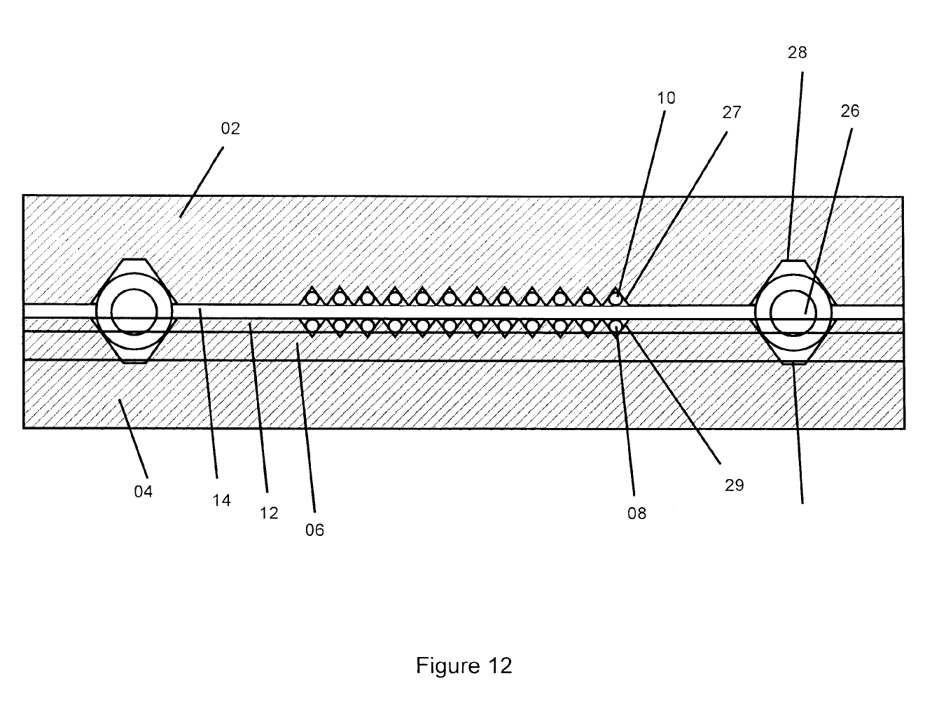

To aid in the precision alignment of the upper silicon v-groove chip [02] with the lower silicon v-groove chip [04], including any glass v-groove chip embodiments, two pairs of larger alignment v-grooves can be used. Similar to the alignment dowel pins of the MT, and similar to other silicon v-groove chip alignments, the two pairs of large alignment v-grooves allow a dowel pin to precisely position the upper optical waveguides over the lower optical waveguides, albeit with a precision glass spacer [14] between the upper and lower v-groove chips. This is illustrated in FIG. 12. Larger silicon v-groove trenches [28], [30] that have been precision-etched with respect to the smaller v-grooves [27], [29] on the same chips, respectively, are provided. By using a short dowel pin [26] between the upper large v-grooves and the lower large v-grooves, the small v-grooves holding the optical waveguides become precision-aligned, and possibly precision-displaced, one on top of the other.

According to another embodiment of the optical connector, the assembly that contains an arranged set of two 1×12 parallel optical waveguides can be constructed using an upper silicon (or glass) v-groove chip and a lower glass v-groove chip. This version is similar to the one described above, except that there is no requirement for the lower glass v-groove chip to be recessed with respect to the upper chip, nor is there a need for the small glass cover. The optical path for both the upper and lower optical fiber arrays is through the lower glass v-groove chip. Therefore, both the silicon and glass v-groove chips, along with the optical waveguides of both chips, can protrude by the same amount. The entire assembly, once joined together, can be placed in a lapping/polishing machine at a 45-degree angle so that the front end of the assembly becomes beveled at 45-degrees, including the tips of the optical waveguides. The beveled tips of all of the optical waveguides are then optically accessible through the bottom of the lower glass v-groove chip.

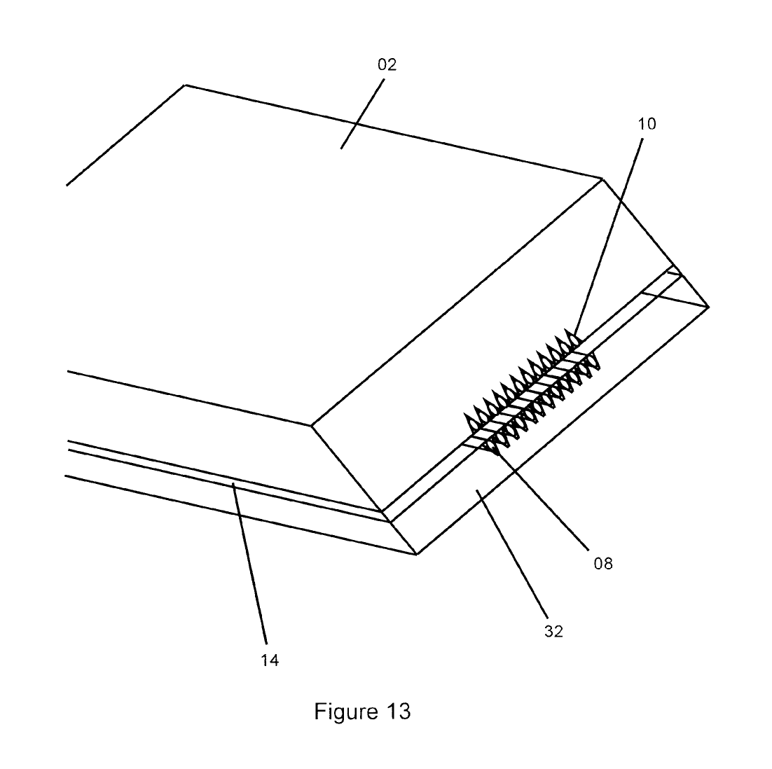

This embodiment of the 2-D optical connector is shown in FIG. 13. The upper v-groove chip can be either silicon or glass [02], and the lower v-groove chip is glass [32]. Unlike the anisotropic etch of the silicon v-grooves, the glass v-grooves can be obtained using micromachining, photolithography and directional etching (such as RIE), as well as any other adequate methods such as transfer molding. Both upper and lower v-groove structures hold the optical waveguides in the same way as the previous embodiments, however there is no longer any need for the glass cover at the front of the assembly. The precision glass spacer [14] remains as part of the assembly, and the transparent epoxy is also used to join the parts together.

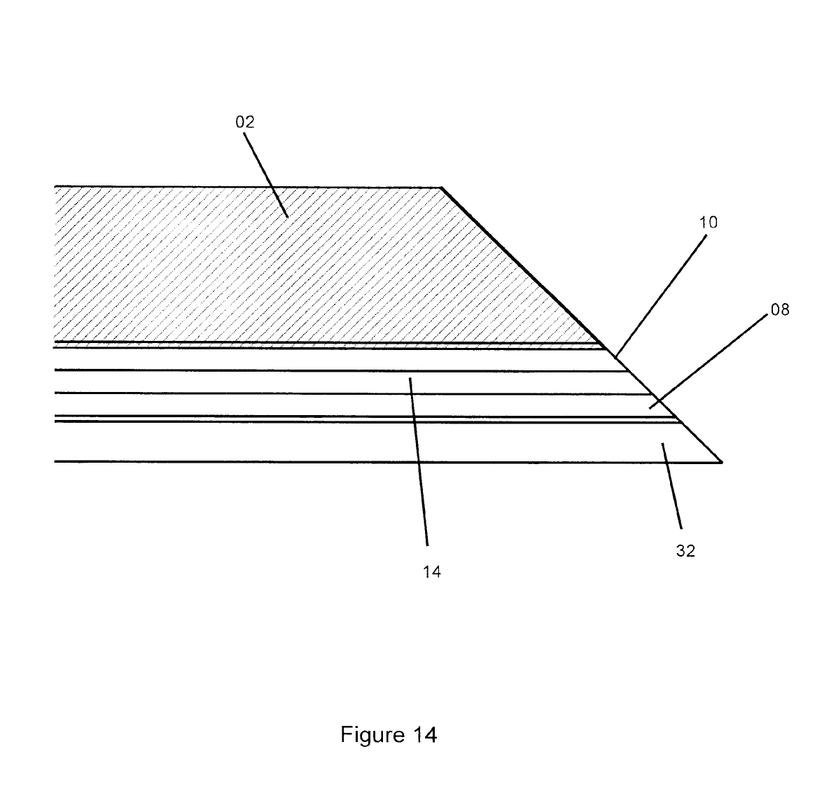

FIG. 14 shows the cut-away side view of the assembly. In this embodiment, the lower glass v-groove chip [32] now serves as a lower reference both for mechanical placement and vertical stack-up, and also for the optical distance between the optical fiber tips and the optical lens system and/or optoelectronics below the 2-D optical connector. Note that all other aspects of the 2-D optical connector remain substantially similar to the previous embodiments.

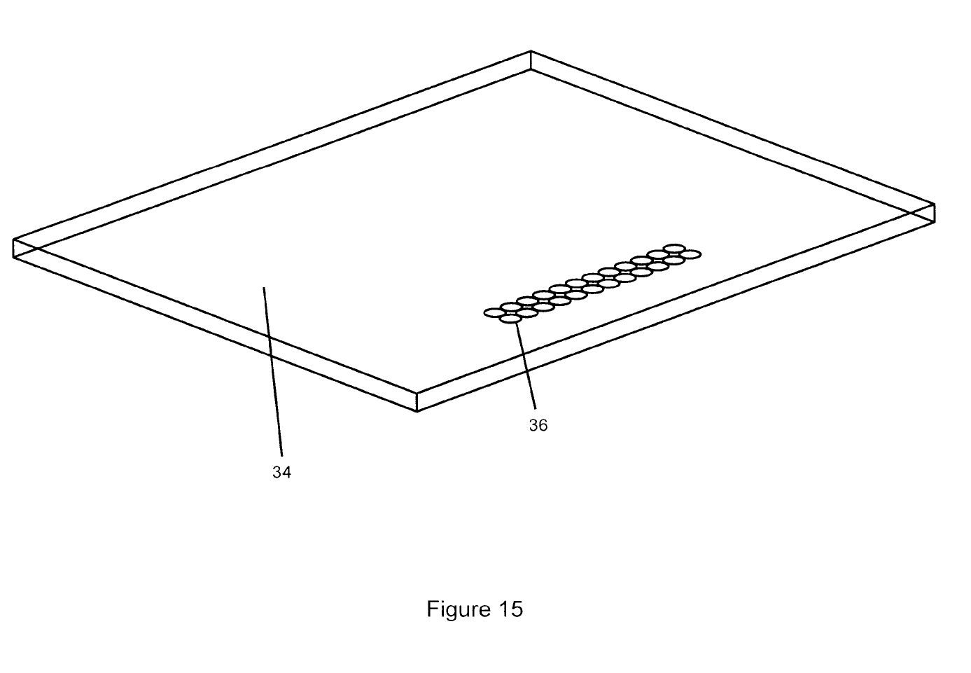

An example of a lens system that can be used to focus light from an array of optoelectronic devices into the array of optical fiber tips in the 2-D optical ferrule is described by FIGS. 15 to 21. The concept of stacking arrays of micro-lenses over optoelectronics and its respective packaging is used here to provide a packaging structure that converts multiple electrical signals into multiple optical signals in a module that has a standard electrical interface and a standard optical interface.

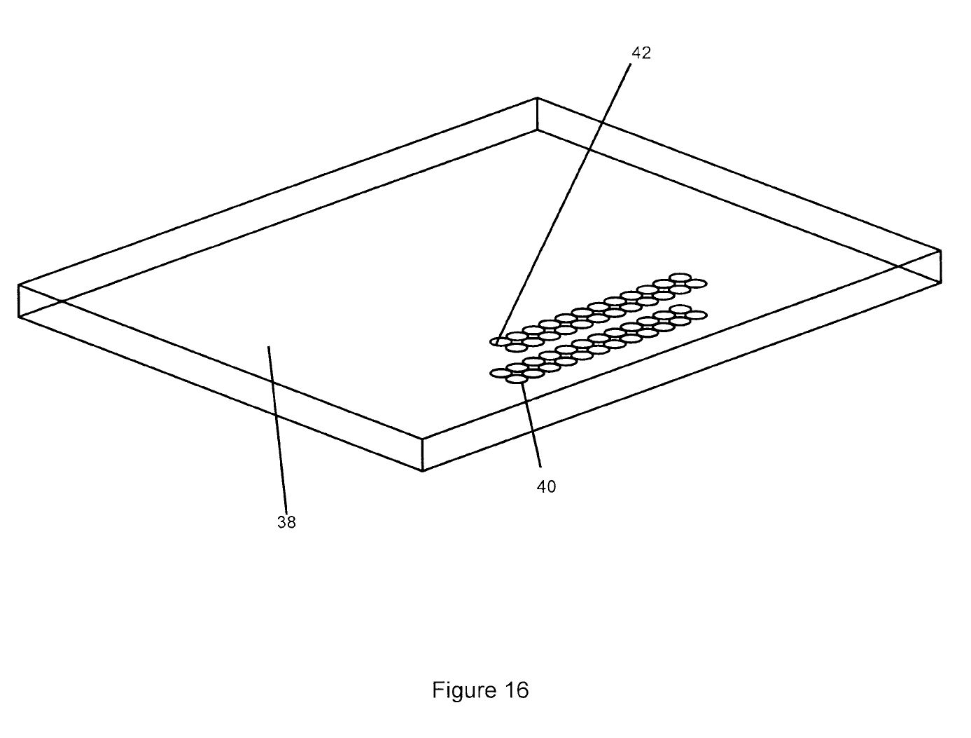

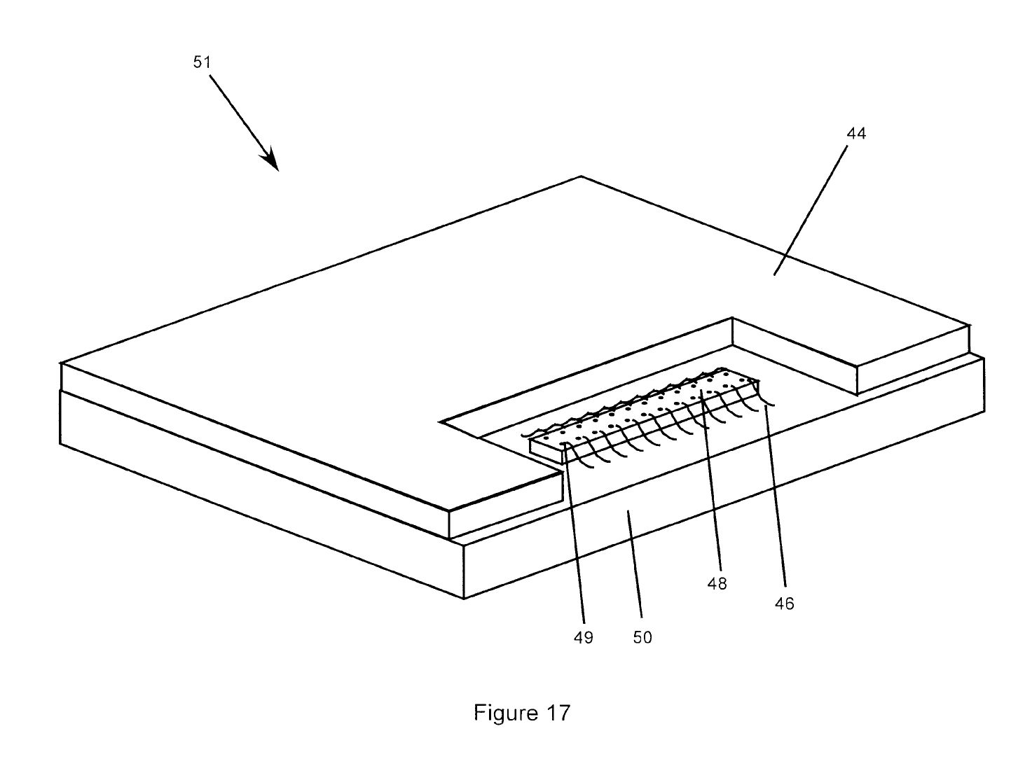

FIG. 15 shows a micro-optical structure that is a glass plate [34], with a 2×12 set of position-etched or patterned micro-lenses [36]. These lenses can be refractive or diffractive structures, or graded index lenses, or any other adequate type of lenses. In the embodiment illustrated, they are Fresnel lenses. FIG. 16 shows a similar micro-lens glass plate [38], but with a bottom side of etched diffractive Fresnel lenses [40] and a top side of etched diffractive Fresnel lenses [42]. These lens pairs are manufactured so that they are directly on top of each other in the vertical direction. FIG. 17 shows a type of optoelectronic carrier with a mounting block [50] and a single 2×12 arrayed optoelectronic chip [48] wire-bonded [46] to the substrate. The active area of an optoelectronic device (such as a VCSEL aperture) [49], points upwards and a spacer material [44] that partially surrounds the optoelectronic chip is slightly thicker than the chip and the wirebond loop heights. This spacer material [44] defines the height of the first lens.

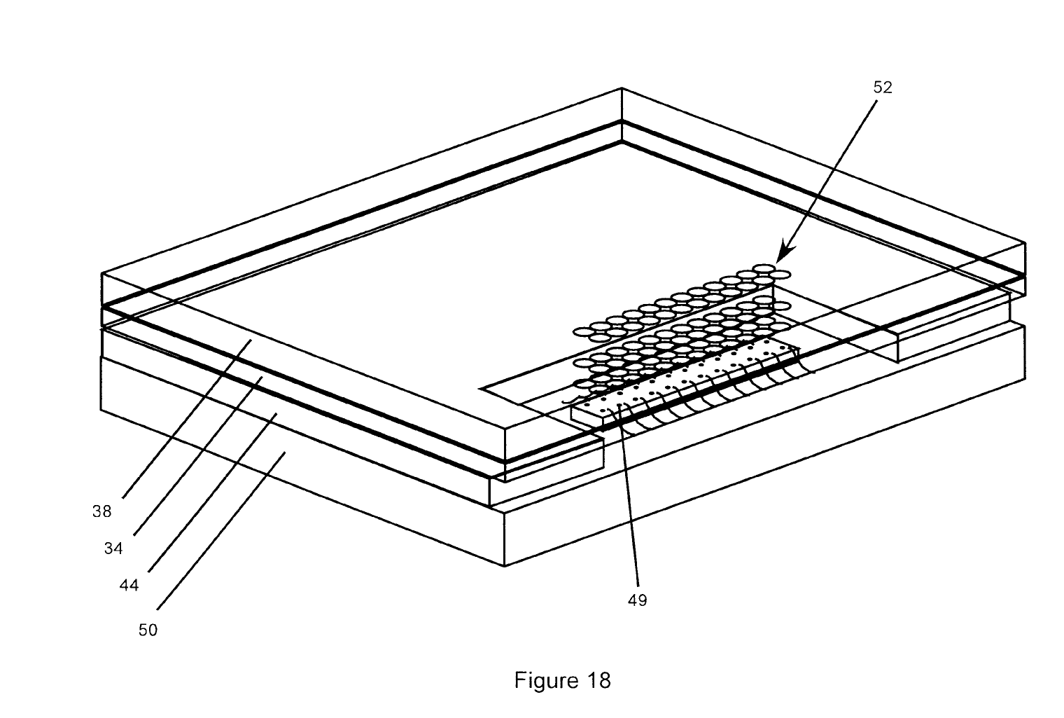

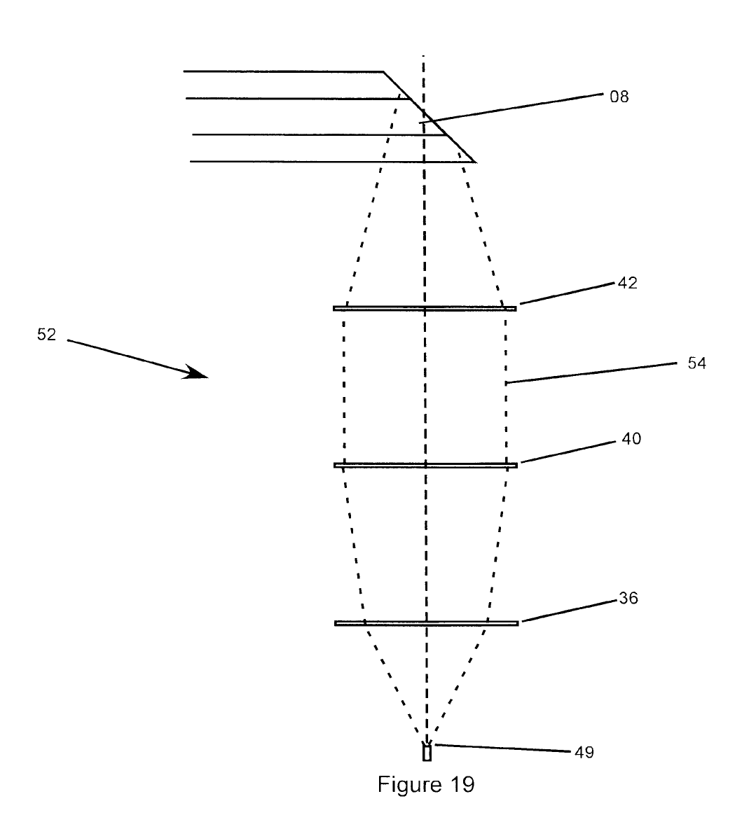

In FIG. 18, the two lens plates [34], [38] and the optoelectronic carrier [51] are stacked on top of each other and aligned in x, y and rotation so that each optoelectronic aperture [49] is centered below each of its three respective lenses. A single element of the optical system [52] is more clearly described in FIG. 19 where the optoelectronic aperture [49] is centered on the first lens [36], the second lens [40] and the third lens [42]. The dashed line [54] is a geometrical representation of the outside ray-trace of the light as it passes through the lens system.

In one embodiment of the lens system of FIG. 19, a short-wavelength emitter (such as an 850-nm VCSEL) is located at the lens system's object plane, and a 50/125 multimode optical fiber [08] is located at the lens system's image plane. This system assumes a slight overfill of the multimode optical fiber core to allow for more tolerance in the x-y misalignment. The optical lens system assumes a 1/ê2 full angle divergence of 30-degrees in air for the VCSEL laser. It is assumed that 99% of the light is contained in a 22.5-degree half angle. Therefore, a weakly focusing first lens is used with focal length of 0.300-mm, and this is placed 0.170-mm above the VCSEL aperture. The weakly focused light travels 0.2-mm through glass, where it diverges to 0.20-mm diameter (slightly smaller than the lens diameter) just before the second lens. The second lens is used to collimate the light with a focal length of 0.500-mm. The collimated light travels through 0.6-mm of glass and reaches a third lens. The third lens has a focal length of 0.500-mm that focuses the light 0.700-mm beyond the third lens. However, the center of the core of the beveled 45-degree tip is placed only 0.350-mm from the third lens so that the light overfills the 50-um multimode core with a 100-um diameter spot. This results in some light loss, but allows for some lateral misalignment tolerance while still achieving a uniform coupling in all optical waveguides. A similar lens system is also possible for the upper optical fiber array as well as the photodetector version of the 2-D optical ferrule where the light is emanating from the optical fiber.

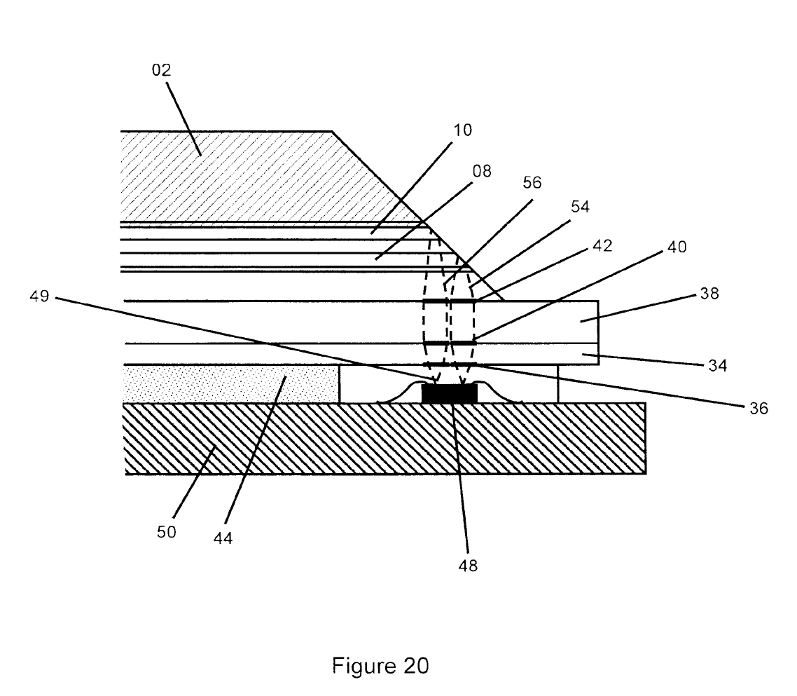

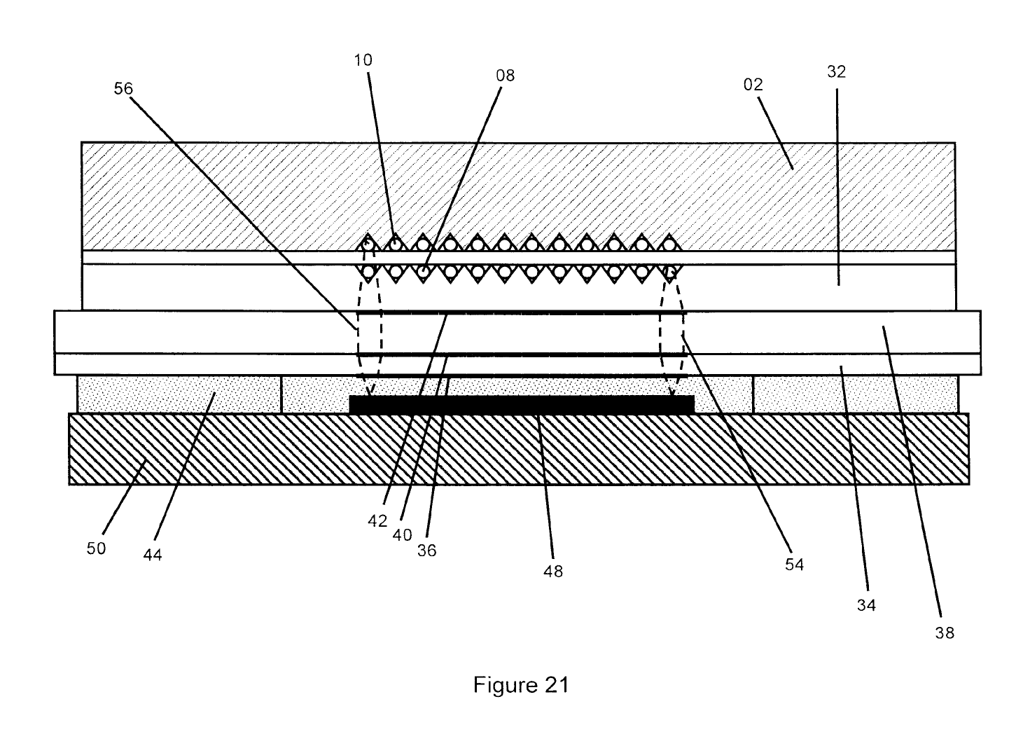

FIG. 20 shows the cut-away side view of an embodiment of a completely aligned optical system including the silicon/glass version of the 2-D optical connector illustrated in FIGS. 13 and 14. FIG. 21 shows the front view of the same complete assembly. Each optoelectronic aperture [49] is aligned through its respective lens system with the beveled end of a corresponding waveguide [08], [10] such that the light from each emitter is incident on the tip of each respective optical fiber tip. The build-up of the structure is done entirely as a vertical stacking of elements and x, y and rotation alignment steps, where the vertical thickness is predefined by the thickness of each element. The 2-D optical connector is aligned to the third lens array by centering each optical fiber tip over the center of each lens. This can be done either passively or actively, and powered or unpowered, and can also involve passive alignment features on the optoelectronic chip, the lens plates and/or the 2-D optical connector.

The coupling of light between the optoelectronic device [49] and the fibers [08], [10] is achieved by side coupling. If the optoelectronic device [49] is a light receiver, light coming from the waveguide [08], [10] is reflected by the beveled end of the waveguide [08], [10] and propagates through the side of the waveguide [08], [10], the substrate [04], and the two lens plates [34], [38] before reaching the receiver [49]. If the optoelectronic device [49] is a light emitter, the light emitted by the emitter [49] propagates through the two lens plates [34], [38], the substrate [04], and the side of the waveguide [08], [10] before being reflected by the beveled end of the waveguide [08], [10].

Note that numerous techniques can be used for optical alignment, and the 2-D optical connector is constructed such that all of the optical waveguides are fixed relative to each other. By moving the 2-D optical connector, all optical waveguides are moved at the same time. This implies that if separate optoelectronic arrayed chips are used, such as a 1×12 emitter array and a 1×12 detector array, these optoelectronic chips are to be initially positioned with very high accuracy. A single, photo-lithographically defined 2×12 array of optoelectronic devices therefore may offer a more easily manufacturable part by lowering the required precision placement steps.

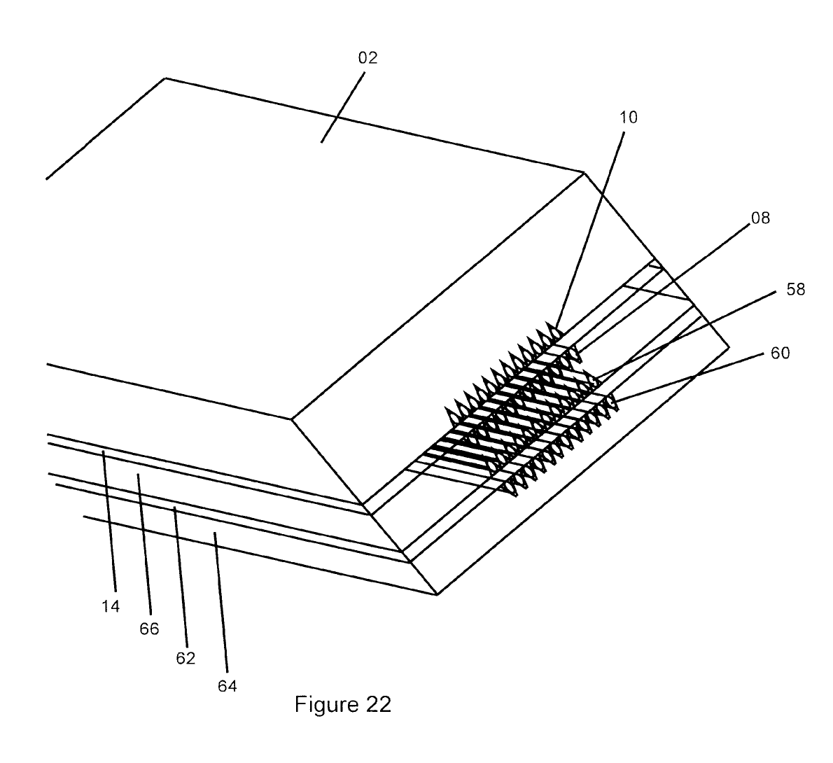

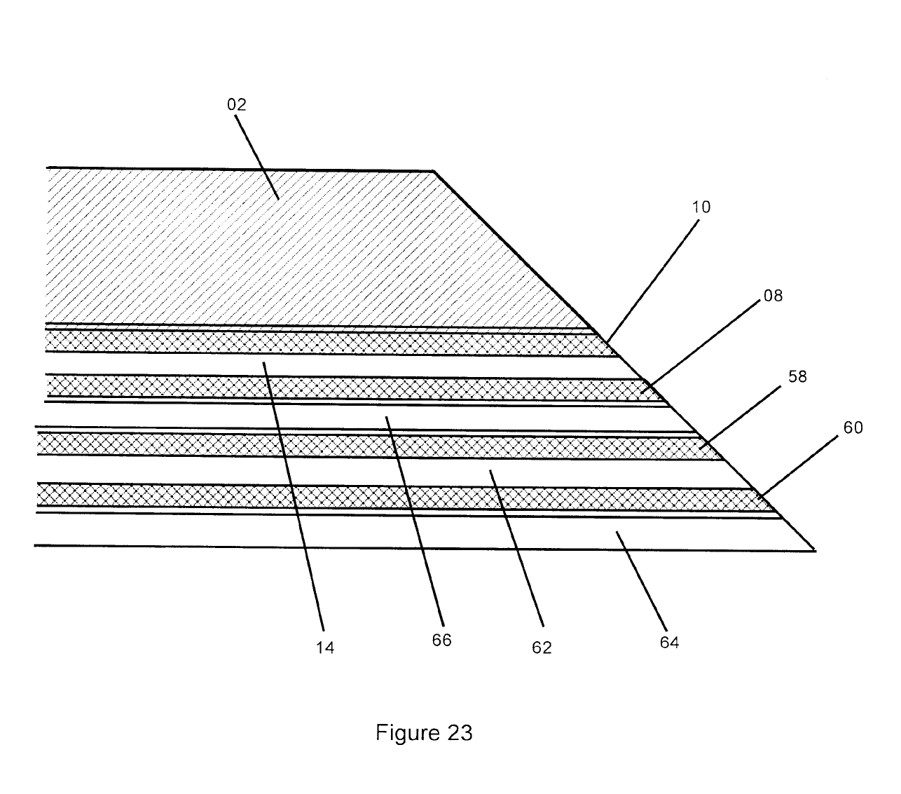

FIGS. 22 and 23 are the perspective view and the cut-away side view, respectively, of a multi-layer array of optical fiber arrays in accordance with one embodiment. This allows an extension to arrays larger than 2×12, such as 3×12, 4×12, and larger. The multi-layer embodiment uses layers of spacers [14], [62] and glass v-groove structures [66], [64] to stack 1×12 arrays of optical waveguides [10], [08] and [58], [60]. The vertical optical path becomes longer and must pass through more lateral sides of optical waveguides. This system carries forward all of the previously described attributes of the 2×12 array 2-D optical ferrule. The lens system requires larger arrays of lenses, but the lenses focusing on the upper most optical fiber tips simply requires longer focal length imaging.

In one embodiment, an optoelectronic carrier for the emitter or detector array is also used, such as the one described in U.S. Pat. No. 7,178,235, the contents of which are hereby incorporated by reference. A version of a ceramic carrier with a spacer and a wire-bonded 2×12 optoelectronic array is used. The ceramic carrier allows electrical signaling to (or from) the optoelectronic array while providing a stackable surface onto which the micro-lens patterned glass plates are placed and pre-aligned to the apertures of the optoelectronics.

In one embodiment, spacers are not used. For example, two substrates having the optical waveguides embedded therein may be stacked, with each set of optical waveguides facing downwards. The second substrate is used as a support for the optical waveguides and as a spacer at the same time. In an embodiment with more than two layers, each substrate having embedded optical waveguides is placed in a same orientation such that all substrates have the surface with grooves facing downwards or upwards. In another example, sets of optical waveguides are positioned such that they are facing each other, but epoxy or another type of material is used to hold the two substrates together and maintain an appropriate positioning and distance between adjacent sets of optical waveguides.

The embodiments described above are intended to be exemplary only. The scope of the invention is therefore intended to be limited solely by the scope of the appended claims.

1. A method for fabricating an optical connector comprising:
embedding each one of a plurality of first optical waveguides in a corresponding one of a plurality of first grooves of a first substrate;
embedding each one of a plurality of second optical waveguides in a corresponding one of a plurality of second grooves of a second substrate;
abutting said plurality of first optical waveguides and said plurality of second optical waveguides against walls of said plurality of first grooves and said plurality of second grooves, respectively, by securing a spacer plate between said first substrate and said second substrate so that said first optical waveguides and said second optical waveguides extend along a same axis, thereby obtaining an optical assembly having a front end substantially perpendicular to said axis; and
beveling said front end of said optical assembly, thereby obtaining a beveled end for said first optical waveguides and a beveled end for said second optical waveguides offset along said axis for separately providing optical access by side coupling to said plurality of first optical waveguides and said plurality of second optical waveguides.

2. The method as claimed in claim 1, wherein said beveling said front end comprises beveling said first substrate, said first optical waveguides, said spacer plate, said second optical waveguides, and said second substrate.

3. The method as claimed in claim 1, wherein said embedding each one of said plurality of second optical waveguides comprises positioning said second optical waveguides within said second grooves so that a portion of said second optical waveguides protrudes from said second substrate.

4. The method as claimed in claim 3, further comprising permanently securing a cover plate to said portion of said second optical waveguides protruding from said second substrate before said beveling, said beveling comprising beveling said cover plate.

5. The method as claimed in claim 3, further comprising:
removably securing a cover plate to said portion of said second optical waveguides protruding from said second substrate before said beveling; and
removing said cover plate after said beveling.

6. The method as claimed in claim 5, wherein said removably securing said cover plate comprises applying a wax between said portion of said second optical waveguides and said cover plate.

7. The method as claimed in claim 1, wherein said securing said spacer plate comprises:
securing a first intermediary plate to said first substrate to abut said plurality of first optical waveguide against said walls of said plurality of first grooves;
securing a second intermediary plate to said second substrate to abut said plurality of second optical waveguides against said walls of said plurality of second grooves; and
securing said first intermediary plate and said second intermediary plate together.

8. The method as claimed in claim 1, further comprising depositing a reflective coating material on at least said beveled end for said first optical waveguides and said second optical waveguides.

9. The method as claimed in claim 1, wherein said securing said spacer plate comprises offsetting in a direction perpendicular to said axis said plurality of first optical waveguides with respect to said plurality of second optical waveguides.

10. The method as claimed in claim 1, wherein said securing said spacer plate comprises aligning each one of said plurality of first optical waveguides with a corresponding one of said plurality of second optical waveguides.

11. An optical connector comprising:
a first substrate comprising a plurality of first grooves extending along an axis on a first waveguide receiving surface;
a second substrate comprising a plurality of second grooves extending along said axis on a second waveguide receiving surface;
a plurality of first optical waveguides, each received in a corresponding one of said plurality of first grooves;
a plurality of second optical waveguides, each received in a corresponding one of said plurality of second grooves; and
a spacer plate secured between said first substrate and said second substrate to abut said plurality of first optical waveguide and said plurality of second optical waveguides against walls of said plurality of first grooves and said plurality of second grooves, respectively, said first substrate, said first optical waveguides, said spacer plate, and said second optical waveguides being beveled at a given end to form a beveled connector end, said given end for said first waveguides and said given end for said second waveguides being offset along said axis for separately providing optical access by side coupling to said plurality of first optical waveguides and said plurality of second optical waveguides.

12. The optical connector as claimed in claim 11, wherein said second substrate is beveled at said given end, said plurality of first optical waveguides and said plurality of second optical waveguides being optically accessible through said second substrate.

13. The optical connector as claimed in claim 11, wherein said second substrate has a front end recessed with respect to said second waveguide beveled end and a portion of said plurality of second optical waveguides protrudes from said front end.

14. The optical connector as claimed in claim 13, further comprising a cover plate secured to said portion of said plurality of second optical waveguides protruding from said front end, said plurality of first optical waveguides and said plurality of second optical waveguides being optically accessible through said cover plate.

15. The optical connector as claimed in claim 11, wherein said spacer plate comprises two layers of a material stacked together.

16. The optical connector as claimed in claim 11, wherein said first grooves are vertically aligned with said second grooves and each one of said plurality of first optical waveguides is vertically aligned with a corresponding one of said plurality of second optical waveguides and optically accessible through said corresponding one of said plurality of first optical waveguides.

17. The optical connector as claimed in claim 11, wherein said first grooves and said second grooves are offset along a direction perpendicular to said axis to provide a waveguide offset between said first optical waveguides and said second optical waveguides.

18. The optical connector as claimed in claim 17, wherein said waveguide offset is half a distance between centers of adjacent ones of said plurality of second optical waveguides.

19. The optical connector as claimed in claim 11, further comprising a reflecting layer coated on said connector beveled end.
